(19) United States
(12) Patent Application Publication
(10) Pub. No.: US 2010/0259448 A1
(43) Pub. Date: Oct. 14, 2010

(54) METHOD AND SYSTEM FOR HEALTH MONITORING OF AN OVER THE AIR GEO-LOCATION SYSTEM

(75) Inventors: MURAD QAHWASH, ORLANDO, FL (US); JOHN McCARTHY, PALM BAY, FL (US); DANNY CAUDILL, MELBOURNE, FL (US); MICHAEL KEEFE, WEST MELBOURNE, FL (US)

Correspondence Address: BEUSSE WOLTER SANKS MORA & MAIRE, P. A., 390 NORTH ORANGE AVENUE, SUITE 2500, ORLANDO, FL, 32801, US

(73) Assignee: LOCUS LOCATION SYSTEMS LLC, WEST MELBOURNE, FL (US)

(21) Appl. No.: 12/757,924

(22) Filed: Apr. 9, 2010

Related U.S. Application Data
(60) Provisional application No. 61/168,208, filed on Apr. 9, 2009.

(51) Int. Cl. G01S 1/24

(52) U.S. Cl. 342/387

(57) ABSTRACT

A method for testing each one of a plurality of receiving sites operative in a time difference of arrival geo-location system. The method comprises determining a theoretical time of arrival of a test message at each receiving site assuming the test message was transmitted from a test message transmitting antenna at a known location; determining a measured time of arrival of the test message at each receiving site, the test message transmitted from the test message transmitting antenna; determining a true time of arrival of the test message at each receiving site, the true time of arrival comprising the measured time of arrival less a start time of the test message; determining a difference between the theoretical and the true times of arrival for each receiving site, wherein the difference for each receiving site is indicative of a health of the receiving site.

### CLAIM OF PRIORITY

The present application claims the benefit, under 35 U.S.C. 119(e), of the provisional patent application filed on Apr. 9, 2009, assigned application No. 61/168,208 and entitled Method and System for Health Monitoring of an Over the Air Geo-Location System.

### FIELD OF THE INVENTION

The invention relates to monitoring the health of receiving sites used in a geo-location system that determines a location of a device emitting a radio-frequency signal.

### BACKGROUND OF THE INVENTION

The Assignee of the present invention has developed and is the owner of an innovative radio location system referred to as the SafePoint® system. This system can locate a mobile or portable radio transmitter when transmitting from outdoors or inside most buildings and vehicles. The system can also locate the transmitter when the signal propagates through smoke, rain, fog and dense foliage.

The SafePoint® system uses time difference of arrival (TDOA) technology for determining the location of a transmitting radio. TDOA geolocation (also referred to as geometric triangulation) is one known technique for determining the location of a radio frequency (RF) transmitting device. A signal transmitted from the mobile or portable device is received by at least three receiving sites (typically ground-based receiving sites). The time of arrival (TOA) of the signal at each receiving site is determined by correlating the received signal with a reference signal stored in a digital signal processor (DSP) at the site. The timing difference between these two signals represents the time of arrival of the signal at the site.

The relationship between distance and time is given by d=ct, where c is the speed of light, t is the propagation or transit time of the signal and d is the distance between the transmitting and the receiving sites. The difference in the arrival time (referred to as the time difference of arrival or TDOA) of the same signal at two receiving sites corresponds to the difference in distance between the transmitting device and each of the two receiving sites.

In the SafePoint® system all receiving sites are synchronized to a 1 PPS (pulse per second) clock transmission from GPS satellites. This clock signal has an accuracy of about 20 nsec. Since each of the n receiving sites is synchronized to the GPS 1 PPS clock, the time of receipt (or time of arrival, TOA) of the same signal at each site is represented by a determined offset from the most recent 1 PPS clock.

When applied to a location system using the TDOA approach, a signal received at n receiving sites yields n time of arrival values and n(n−1)/2 pairs of TDOA values. Each pair-wise TDOA value generates a locus of points in the form of a hyperbola. An intersection of at least three hyperbolae uniquely determines the location of the transmitting device. For more details of this system, see the commonly-owned application entitled A CRC-Based Message Detection/Demodulation Apparatus and Method for Radio Frequency Signals filed on Apr. 23, 2007 and assigned application Ser. No. 11/738,634.

The accuracy of the determined radio location depends significantly on the accuracy of the individual TOA measurements at each receiving site. A TOA with a large error, due for example to software bugs or hardware problems at a receiving site, causes a large shift in the estimate of the location of the transmitting radio. TOA errors due to software bugs are usually discovered through laboratory testing of the receiving site equipment prior to field installation. These errors are typically the same for all receiving sites and therefore all TOA estimates are equally impacted. TOA errors caused by equipment damage or a configuration change at any one antenna site can occur at any time and such errors are unique to the affected site. Adding tower-top amplifiers at a receiving site or physical damage to the site's antenna due to environmental conditions are two examples of physical problems that lead to TOA errors.

Some TOA errors are permanent and others are temporary. For example, adding a tower-top amplifier causes a permanent error in the TOA due to the delays encountered while processing the received signal through this amplifier. But losing the GPS satellite signal results in only a temporary offset error. It is important to detect when an unexpected delay occurs and to advise a central analysis processor (CAP) (the device in the SafePoint® system that determines the location of the transmitting radio by analyzing the TOA from a plurality of receiving sites) of the delay before using that site's TOA in the TDOA calculation to determine the transmitter's location. Once made aware of the delay, the CAP can eliminate that site's TOA from the location calculation, until the delay is rectified, or the CAP can compensate for the error if the magnitude of the error is known.

There are, in effect, multiple time periods that comprise the time of arrival of a signal at each receiving site. The signal must propagate from the transmitting device to the antenna at the receiving site. This propagation time will be different for each site since each is at a different distance from the transmitter. The received signal then travels from the antenna to the electronics processing components at the receiving site. To determine the time of arrival of the signal, it must then be processed through these electronic components. The electronics components comprise an ADDIR (ADvanced Digital Receiver), DSP, etc. Since all receiving sites are synchronized to the GPS 1 PPS clock, the SafePoint® system measures the time of arrival of the same signal at each receiving site from the most recent 1 PPS GPS clock pulse.

### BRIEF DESCRIPTION OF THE DRAWINGS

The invention is explained in the following description in view of the drawings that show:

FIG. 1 is an illustration of principle components of a geo-location system pertinent to the present invention.

### DETAILED DESCRIPTION OF THE INVENTION

Before describing in detail the particular methods and apparatuses related to health monitoring of an over the air geo-location system in accordance with various aspects of the present invention, it should be observed that the present invention, in its various embodiments, resides primarily in a novel and non-obvious combination of hardware, method steps and software elements related to these methods and apparatuses. Accordingly, the hardware, method steps and software elements have been represented by conventional elements in the drawings, showing only those specific details that are pertinent to the present invention so as not to obscure the disclosure with structural details that will be readily apparent to those skilled in the art having the benefit of the description herein.

The following embodiments are not intended to define limits of the structures or methods of the invention, but only to provide exemplary constructions. The embodiments are permissive rather than mandatory and illustrative rather than exhaustive.

The purpose of this invention is to determine when to use and when to eliminate an individual antenna site (also referred to as a receiving site) from the time difference of arrival (TDOA) matrix used to determine the location of a trunked radio (e.g., a portable or mobile radio transmitter). Alternatively, in lieu of eliminating a receiving site from the TDOA calculation, it may be possible to compensate for any delays or timing errors introduced into the TDOA calculation due to performance anomalies at the receiving site.

As explained further below, the present invention determines (and eliminates or compensates) any difference between a measured TOA and a theoretical TOA. This difference is likely caused by an anomaly in processing the signal at the site, another site-specific aberration or a propagation delay due for example to multipath signal effects. Of course the present invention determines this difference without requiring a technician to visit each site, since any installation of the SafePoint® system includes hundreds of such receiving sites, making a personal visit to each site expensive and time consuming. If the difference exceeds a predetermined value, the site is removed from consideration in determining the location of a mobile or portable transmitter or at least the location as determined by the problematic site is discounted when the location is considered with other sites that have also determined the location.

According to the present invention, a fixed-location transmitter (i.e., a test message transmitter) transmits a test message every T minutes (or every T seconds) for receiving by all receiving sites, including a reference receiving site. The distance from the test message transmitter to each receiving site (including the reference receiving site) is known and thus the theoretical propagation time to each site can be determined. Further, the transit time from the antenna to the electronics components at each site can be determined from a length of the cable connecting the antenna to the electronics components. Finally the processing time through the electronics components can be determined by testing these components prior to installation at a receiving site. Since each site has a standard complement of electronics components, the processing time should be uniform across all receiving sites.

If the start of the test message can be accurately controlled, relative to a 1 PPS GPS clock for example, then each site can determine the actual TOA of the test message. Note that in the SafePoint® system all times of arrival are measured from the most recent GPS 1 PPS clock, although this feature is not necessarily required for implementation of the present invention. Assuming that the test message is transmitted precisely at one of the GPS 1 PPS pulses, then:

TOA_{Actual}=detection of test message−start of test message transmission.

The theoretical TOA at each site includes the time required for propagation of the signal from the test message transmitter to the receiving site, transit time through the cable at the receiving site, and signal processing time at the receiving site. The theoretical TOA is determinable from:

TOA_{Theoretical}=d/c+L/c+t_{Processing} (1)

where d is the distance from the test message transmitter to the receiving site, c is the speed of light, L is the length of the cable connecting the antenna to the electronics components and t_{Processing} is the processing time through the electronics components at the receiving site. Thus according to this vernacular, the time of arrival of a signal at a receiving site in fact includes the propagation time to the receiving site, the transit time and the processing time.

In the above calculations it is assumed that the start of the test message transmission can be controlled relative to the GPS 1 PPS clock, and in fact the test message is sent precisely at the occurrence of a GPS clock pulse. However this is not possible for a distributed system of receiving sites, such as the SafePoint® system.

To establish a known start time of a test message transmission, all receiving sites need to synchronized with the test message transmitter and the transmitter must be accurately controlled to transmit at a specific time. These requirements may be met in a small-area system where all sites are physically connected and thus synchronized, and where a digital transmitter transmits the test message. In the SafePoint® TDOA system sites may be separated by several miles and further the system includes analog transmitters that cannot be controlled with nanosecond accuracy. Therefore another technique for determining the actual/measured and the theoretical TOA at each receiving site is required. Advantageously, the present invention does not require synchronization of the receiving sites relative to the time when the test message is transmitted.

A description of the inventive technique is set forth below.

All receiving sites are synchronized/triggered by the GPS 1 PPS clock. That is, in the SafePoint® system all measured TOA's are determined relative to an immediately-previous GPS 1 PPS pulse.

Each site determines a test message TOA that is expressed as an offset from the 1 PPS clock, referred to as the clock offset. Ideally, the test message transmitter is gated to transmit precisely at a GPS 1 PPS clock tick. The clock offset for each site is then zero. In one configuration of the SafePoint® system the test message transmitter is an analog radio. It is known by those skilled in the art that it is not possible to trigger an analog radio with nanosecond accuracy. The clock offset is therefore not zero in a practical installation.

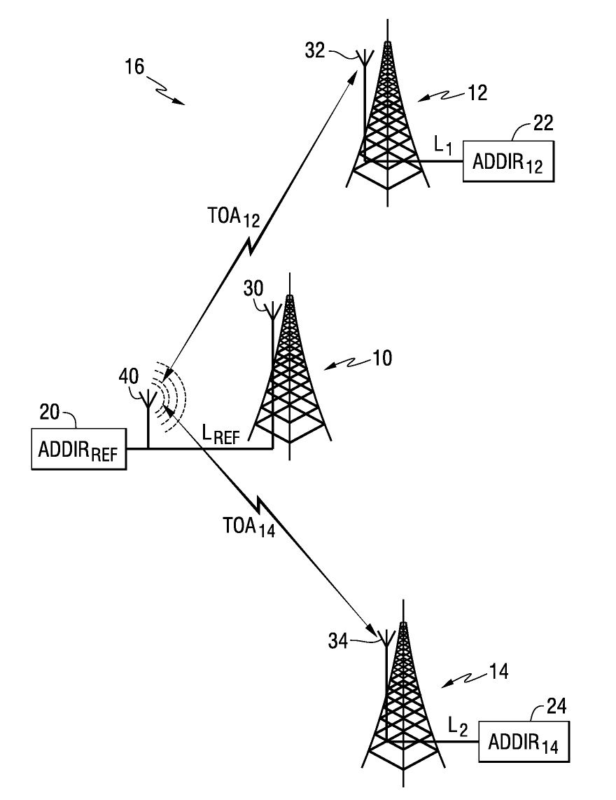

The test message transmitter is co-located at one of the receiving sites (referred to as a reference site). See FIG. 1. The distance between the test message transmitter and the receiving antenna, both located at the reference site, is determined and designated d_{Ref}.

After the test message is transmitted from the transmitting antenna it propagates to the receiving antenna at the reference receiving site in a time d_{Ref}/c. See FIG. 1. The RF signal then travels from the receiving antenna through a cable of length L to the ADDIR and related electronics components at the reference site, referred to as the ADDIR_{Ref}.

The ADDIR_{Ref} generates a reference TOA (TOA_{Ref}) (i.e., the time when the test message was detected at the reference receiving site) that includes a sum of the propagation time of the test message from the antenna connected to the test message transmitter (which is co-located at the reference site) to the receiving antenna also at the reference site (d_{Ref}/c), the signal travel time from the receiving antenna to the ADDIR_{Ref} (L_{Ref}/c), and the signal processing time through the electronic components at the reference site (t_{Ref Processing}). The first and second of these three values can be determined from two distance measurements and the third value, the signal processing time, can be determined from laboratory testing. Typically the propagation time component of TOA_{Ref} represents the shortest propagation time from among all the receiving radios since both the test message transmitter and the test message receiving antenna are co-located at the reference site. Thus this propagation time is likely to include the fewest and the shortest duration errors. Thus the TOA_{Ref} parameter can be determined from

TOA_{Ref}=clock offset from 1 PPS+d_{Ref}/c+L_{Ref}/c+t_{Ref Processing} (2)

TOA_{Ref} is measured from the most recent 1 PPS clock pulse, i.e., the TOA_{REF} is a time value expressed as a duration from the last 1 PPS clock pulse, thus the appearance of the term “clock offset from 1 PPS” in equation (2).

The time when the test message was transmitted, referred to as TXₛₜₐᵣₜ, equals the offset from the 1 PPS clock (the quantity “clock offset from 1 PPS” in equation (2)), since all times are measured with respect to the most recent GPS clock pulse. This TXₛₜₐᵣₜ value can be determined by rearranging the parameters of equation (2) to yield:

TXₛₜₐᵣₜ=TOA_{Ref}−d_{Ref}/c−L_{Ref}/c−t_{Ref Processing} (3)

The first quantity to the right of the equal sign of equation (3) is the determined time of arrival at the reference site, the second and third quantities can be calculated from the measured distance, and the fourth quantity can be measured in the laboratory as described above. Thus the time, relative to the most recent 1 PPS clock pulse, when the test message was transmitted, TXₛₜₐᵣₜ, can be determined.

The signal delays due to the antenna cable length (L_{Ret}/c and also referred to as the transit time) and the signal processing through the tuner and DSP circuits (t_{Ref Processing}) are known for each site and can be adjusted for or eliminated from consideration in the system of the invention and in the equations above.

A theoretical or expected TOA for each site X can be determined from the known distance (d) between the test message transmitter and the site X, the known transit time from the antenna to the electronics components (e.g., receiving components), the known signal processing time through the electronic components (as described above) and the speed of light.

True TOAs (TTOAs) for the test message at each site X can be determined by subtracting the TXₛₜₐᵣₜ value from the measured TOA at each site X.

TTOA_{X}=TOA_{X}−TXₛₜₐᵣₜ (4)

The TTOA (at the site X, for example) indicates the actual clock time (or offset from the 1 PPS clock) from the transmission of the test message to the determination of its time of arrival at the site X. That is, the TTOA at the site X is independent of the time when the test message was transmitted.

The health of each site is determined by evaluating the difference between the theoretical TTOA for a site X and the true TOA (TTOA as determined from equation (4)) at the site X (TTOA_{X}) for the test message. Any difference between these two values indicates an unexpected delay due to an abnormality at the site X. Based on these test results, the site X can be removed from consideration when the location of a portable or mobile radio is to be determined, thereby resulting in a more accurate location determination. The threshold for discarding the TOA determined at a site X is flexible and may be dependent on the number of remaining sites from which the location can be determined after the site X is discarded. That is, if a large number of receiving sites are discarded from the location calculation the resulting location determination may not be accurate. Thus the threshold for discarding a site from the location determination can depend on the number of “good” receiving sites.

Alternatively, the unexpected delay can be compensated out by subtracting this delay value from the time of arrival of the signal at the site X. However, it must be recognized that this delay may not be present for all mobile radios for which the location must be determined. For example, the unexpected delay may be the result of transient multipath propagation that may not be present for other portable radios at different locations (or at different times). Thus removing the receiving site radio from consideration may be preferable to trying to compensate for the unexpected delay.

In lieu of discarding a site TOA value or compensating for the site TOA value, the difference between the theoretical TTOA and the true TOA (TTOA) determines a weight value applied to a location determined by the receiving site. This yields a weighted determined location that is used by the geo-location system to determine a location of the portable or mobile radio.

The test procedure of the present invention is repeated about every T seconds or every T minutes to update the health of each site without expensive equipment and without physically testing each individual site by sending a technician to the sites to determine the accuracy of the TOA information at the site. If testing reveals that the health of a site X has improved (i.e., the abnormality was repaired or the abnormality was transient) to the point where the theoretical TTOA and the measured TTOA are equal or the difference is within a predetermined acceptable margin, then the site X is again used to determine a location of the mobile or portable transmitter.

The system may have a plurality of reference receiving sites to reveal any problems (e.g., unexpected delays) at a single reference receiving site. A voting arrangement among the reference sites may be implemented, with the voting results determining whether a reference site should be eliminated from use or how the TXₛₜₐᵣₜ value for the entire system should be computed.

The present invention does not require physical synchronization among the receiving sites. Over-the-air calibration of the times of arrival at each site can be achieved. No expensive equipment is needed to transmit the test message with accurate timing.

Following is an example illustrating operation of the present invention. FIG. 1 depicts a simple setup of a reference receiving site 10, and geo-location receiving sites 12 and 14 of a geo-location system 16. The receiving sites 10, 12 and 14 are associated with respective ADDIR's (receivers) 20, 22 and 24 and associated receiving antennas 30, 32 and 34.

Assume it has been determined that the test message was transmitted from a transmitting antenna 40 at an offset of 500 ns from the most recent 1 PPS GPS clock pulse. This value is referred to as TXₛₜₐᵣₜ in equations (3) and (4) above and in a real-world situation is determined as explained above.

Recall that the absolute transmission time of the test message and the absolute time of each GPS 1 PPS cannot be determined as explained above, thus it is necessary to use the determined offset value in the pertinent calculations.

Also assume that the distance to the site 12 is 2000 m (d₁₂=2000 m) and the distance to the site 14 is 3000 m (d₁₄=3000 m). To simplify this example calculation, assume the cable length at both sites 12 and 14 is the same as the cable length at the reference receiving site (L_{Ref}) resulting in an identical theoretical transit time at each site. The theoretical transit time at each of the three sites is determined from the cable length and the speed of light and for this example is assumed to be 400 ns. Also the processing time through the electronic components at the reference site and the sites 12 and 14 (t_{Ref Processing}) is determined to be the same for each site and assumed to be 10 ns for this example.

In a real-world implementation of this invention the transit time and the processing time at each receiving site must be determined as explained above.

The theoretical propagation time from the antenna site 12 is therefore:

d₁₂/c=2000 m/c=6666 ns,

and the theoretical TOA for antenna site 12 is therefore:

6666+400+10=7076 ns

The theoretical propagation time for antenna site 14 is:

d₁₄/c=3000 m/c32 10000 ns

and the theoretical TOA for antenna site 14 is therefore:

10000+400+10=10410 ns

From equation (4), the theoretical true TOA (i.e., the theoretical TTOA) for antenna site 12 is the theoretical TOA less TXₛₜₐᵣₜ:

Theoretical TTOA₁₂=6666−500 =6166 ns

From equation (4), the theoretical true TOA (i.e., the theoretical TTOA) for antenna site 14 is the theoretical TOA less TXₛₜₐᵣₜ:

Theoretical TTOA₁₄=7076−500=6576 ns

The theoretical TTOA values determined above for the antenna sites 12 and 14 serve as baseline values when the health of these sites is later checked by measuring actual TTOA values for each site. If later-determined test message actual TTOA values for site 12 or site 14 differ appreciably from the baseline values above, and if the test message actual TTOA results are determined not to be transient, the errant site is declared a problem site. The extent of the difference required to declare a receiving site a problem site is user selectable.

Any time of arrival values determined at the problem site may be ignored when determining the location of a mobile transmitter. It may also be necessary to dispatch a service technician to the problem site to further investigate and determine a root cause of the delays there. The root cause may be related to any one or more of the three components of the TOA, i.e., the propagation time, the transit time from the receiving antenna to the electronics components and the processing time through the electronics components. If the root cause of the delay and its magnitude are determined, the TOA value can be corrected or adjusted. The corrected or adjusted (compensated) TOA value can then be used in the location determination algorithm.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A method for testing each one of a plurality of receiving sites operative in a time difference of arrival geo-location system for determining a health of each receiving site, the method comprising:
determining a theoretical time of arrival of a test message at each receiving site assuming the test message was transmitted from a test message transmitting antenna at a known location;
determining a measured time of arrival of the test message at each receiving site, the test message transmitted from the test message transmitting antenna;
determining a true time of arrival of the test message at each receiving site, the true time of arrival comprising the measured time of arrival less a start time of the test message; and
determining a difference between the theoretical and the true times of arrival for each receiving site, wherein the difference for each receiving site is indicative of a health of the receiving site.

2. The method of claim 1 wherein if the difference is less than a predetermined value the receiving site continues as an active receiving site in the geo-location system and wherein if the difference is greater than a predetermined value to receiving site is eliminated as an active receiving site in the geo-location system.

3. The method of claim 2 wherein the predetermined difference is responsive to a number of active receiving sites.

4. The method of claim 1 wherein the difference determines a weight value applied to a location determined by the receiving site yielding a weighted location determination used by the geo-location system to determine a location of a transmitting device.

5. The method of claim 1 wherein the step of determining the theoretical time of arrival at each receiving site further comprises:
determining a distance d from the test message transmitting antenna to each receiving site;
determining a propagation time from the test message transmitting antenna to an antenna at each receiving site, the propagation time responsive to the distance d and the speed of light;
at each receiving site, determining a transit time from the antenna to receiving components; and
at each receiving site, determining a signal processing time through the receiving components; and
wherein the theoretical time of arrival at each receiving site is a sum of the propagation time, the transit time, and the signal processing time at that receiving site.

6. The method of claim 1 wherein the theoretical, measured and true times of arrival are measured relative to a most recent clock pulse received at each receiving site.

7. The method of claim 6 wherein the clock pulse comprises a 1 PPS clock pulse as transmitted from a GPS satellite.

8. The method of claim 1 wherein determining the start time of the test message comprises:
determining a reference time of arrival (TOA_{Ref}) of a test message at a reference receiving site and subtracting from TOA_{Ref}, a propagation time of the test message from the test message transmitting antenna to a test message receiving antenna at the reference receiving site, and subtracting a transit time from the test message receiving antenna to signal processing components where the TOA_{Ref} value is determined, a result equal to the start time of the test message.

9. The method of claim 8 wherein the transit time from the test message receiving antenna to signal processing components where the TOA_{Ref} value is determined comprises, a determined transit time from the test message receiving antenna to receiving components at the reference receiving site (L_{Ref}/c), and a determined signal processing time through the receiving components at the reference receiving site (t_{Ref Processing}).

10. The method of claim 8 wherein the test message transmitting antenna and the test message receiving antenna are collocated at the reference receiving site.

11. The method of claim 8 comprising a plurality of reference receiving sites each having a test message receiving antenna, wherein a start time is determined at each one of the plurality of reference receiving sites and compared to determine how the determined start times should be used to determine a start time for use in testing the plurality of receiving sites operative in the time difference of arrival geo-location system.

12. The method of claim 1 wherein determining the start time of the test message comprises:
determining a reference time of arrival (TOA_{Ref}) of a test message at a reference receiving site, the reference time of arrival at the reference receiving site responsive to a sum of a determined offset from a clock pulse when the test message was received, a determined propagation time from the test message transmitting antenna to a test message receiving antenna at the reference receiving site (d_{Ref}/c), a determined transit time from the test message receiving antenna to receiving components at the reference receiving site (L_{Ref}/c), and a determined signal processing time through the receiving components (t_{Ref Processing}); and
determining a start time of test message transmission (TXₛₜₐᵣₜ) according to the equation
TXₛₜₐᵣₜ=TOA_{Ref}−d_{Ref}/c−L_{Ref}/c−t_{Ref Processing}.

13. The method of claim 12 wherein the test message transmitting antenna and the test message receiving antenna are collocated at the reference receiving site.

14. The method of claim 12 comprising a plurality of reference receiving sites each having a test message receiving antenna, wherein a start time is determined at each one of the plurality of reference receiving sites and compared to determine how the determined start times should be used to determine a start time for use in testing the plurality of receiving sites operative in the time difference of arrival geo-location system.

15. The method of claim 1 wherein the method for testing each of the plurality of receiving sites is executed periodically.

16. The method of claim 1 wherein the difference indicates an unexpected delay at the receiving site, and wherein the delay is compensated at the receiving site during operation of the geo-location system.

17. A method for testing each one of a plurality of receiving sites operative in a time difference of arrival geo-location system for determining a health of each receiving site, the method comprising:
determining a theoretical time of arrival of a test message at each receiving site assuming the test message was transmitted from a test message transmitting antenna at a known location, the theoretical time of arrival measured from a clock pulse, a step of determining a theoretical time of arrival comprising:
determining a distance d from the test message transmitting antenna to each receiving site;
determining a propagation time from the test message transmitting antenna to an antenna at each receiving site, the propagation time responsive to the distance d and the speed of light;
at each receiving site, determining a transit time from the antenna to receiving components; and
at each receiving site, determining a signal processing time through the receiving components; and
wherein the theoretical time of arrival at each receiving site is a sum of the propagation time, the transit time, and the signal processing time at that receiving site.
determining a measured time of arrival of the test message at each receiving site, the test message transmitted from the test message transmitting antenna, the measured time of arrival measured from a clock pulse;
determining a true time of arrival of the test message at each receiving site, the true time of arrival comprising the measured time of arrival less a start time of the test message, the start time measured from a clock pulse, a step of determining the start time comprising:
determining a reference time of arrival (TOA_{Ref}) of the test message at a reference receiving site, the reference time of arrival at the reference receiving site responsive to a sum of a determined offset from a clock pulse when the test message was received, a determined propagation time from the test message transmitting antenna to a test message receiving antenna at the reference receiving site (d_{Ref}/c), a determined transit time from the test message receiving antenna to receiving components at the reference receiving site (L_{Ref}/c), and a determined signal processing time through the receiving components (t_{Ref Processing}); and
determining the start time of test message transmission (TXₛₜₐᵣₜ) according to the equation
TXₛₜₐᵣₜ=TOA_{Ref}−d_{Ref}/c−L_{Ref}/c−t_{Ref Processing}; and
determining a difference between the theoretical and the true times of arrival for each receiving site, wherein the difference for each receiving site is indicative of a health of the receiving site.
